(19) United States
(12) Patent Application Publication
(10) Pub. No.: US 2009/0282326 A1
(43) Pub. Date: Nov. 12, 2009

(54) Process for obtaining a result between a first numerical value and a second numerical value which are separated by a common character in a spreadsheet

(76) Inventor: Carlos Raul Espinosa-Montalvo, Quito (EC)

Correspondence Address: Carlos Espinosa-Montalvo, P.O. Box 17-07-8819, Quito, EC

(21) Appl. No.: 12/149,981

(22) Filed: May 12, 2008

(51) Int. Cl. G06F 17/00

(52) U.S. Cl. 715/219

(57) ABSTRACT

A process for obtaining a result between a first numerical value and a second numerical value which are separated by a common character using a formulas in a plurality of cells of a spreadsheet is provided. If a user selects, copies and pastes a data from an application software to the spreadsheet, and the data have the common character between the two numerical values, the result is obtained using the formulas in the plurality of cells without utilizing a worksheet program for converting text to column. If the user selects, copies and pastes a new data from the application software to the spreadsheet, with this process the result is obtained using less instructions in the spreadsheet than the worksheet program to convert text to column.

### BACKGROUND OF THE INVENTION

### Field of Invention

This invention relates to process for obtaining a result between two numerical values which are separated by a common character in a spreadsheet.

### BACKGROUND OF THE INVENTION

Users of a spreadsheet in a computer for obtaining a result in a data need to compare at least two numerical values of the data.

The data are selected and copied from an application software and then pasted in the spreadsheet. The operations of selecting, copying and pasting the data reduce an analysis time and a number of errors, compared to manually entered data in the spreadsheet.

When the data in the spreadsheet have the numerical values mixed with a characters or a symbols, the numerical values are separated from the characters to obtain the result. Users of spreadsheets separate the numerical values and the characters by utilizing a worksheet program for converting text to columns; however, the worksheet program for splitting the data increases the analysis time and the number of errors in the spreadsheet because several instructions must be done manually in the spreadsheet.

Thus, there is a need for a process for obtaining the result of the numerical values mixed with the characters selected by a user that has reduced the analysis time and the number of errors as compared to other processes.

### OBJECTS AND ADVANTAGES

Accordingly, besides the objects and advantages of the process for obtaining the result of the numerical values mixed with the characters described in my above patent, several objects and advantages of the present invention are:

(a) to provide a process for obtaining a result between a first numerical value and a second numerical value which are separated by a common character and can be used with a variety of a built-in worksheet functions in a spreadsheet;

(b) to provide a process for obtaining a result between a first numerical value and a second numerical value which are separated by a common character and can replace a worksheet program for converting text to columns in a spreadsheet; and

(c) to provide a process for obtaining a result between a first numerical value and a second numerical value which are separated by a common character and can be used with a same number of columns in a spreadsheet.

Still further objects and advantages will become apparent form a consideration of the ensuing description and drawings.

### SUMMARY OF THE INVENTION

A process for obtaining a result between a first numerical value and a second numerical value which are separated by a common character in a plurality of cells with formula in a spreadsheet is provided. The process includes using an application software in a computer and having a data in the application software, and having a plurality of values in the data, and having the plurality of values the first numerical value and the second numerical value which are separated by the common character. The process further includes selecting the data in the application software. The process further includes copying the data in the application software. The process further includes using the spreadsheet and selecting a cells of data in a worksheet. The process further includes pasting the data in the cells of data. The process further includes identifying a column having a plurality of cells with the plurality of values in the cells of data. The process further includes providing a column having the plurality of cells with formula referred directly to the column having the plurality of cells with the plurality of values. The process further includes providing a worksheet function in the plurality of cells with formula for finding the common character in the plurality of cells with the plurality of values. The process further includes providing a worksheet function in the plurality of cells with formula for finding the first numerical value in the plurality of cells with the plurality of values using the function for finding the common character in the plurality of cells with the plurality of values. The process further includes providing a worksheet function in the plurality of cells with formula for finding the second numerical value in the plurality of cells with the plurality of values using the function for finding the common character in the plurality of cells with the plurality of values. Finally, the process includes providing a worksheet function in the plurality of cells with formula for obtaining the result between the first numerical value with the second numerical value using an inequality.

These and other features and advantages of the invention will become apparent to those skilled in the art upon review of the following drawings, the detailed description, and the appended claims.

### BRIEF DESCRIPTION OF THE DRAWINGS

FIG. 1 is a block diagram showing an application software and a spreadsheet according to the embodiments of the present invention.

FIG. 2 is a block diagram showing a worksheet according to the embodiments of the present invention.

### DETAILED DESCRIPTION OF THE INVENTION

Referring to the drawings, identical reference numerals represent identical components in the various views.

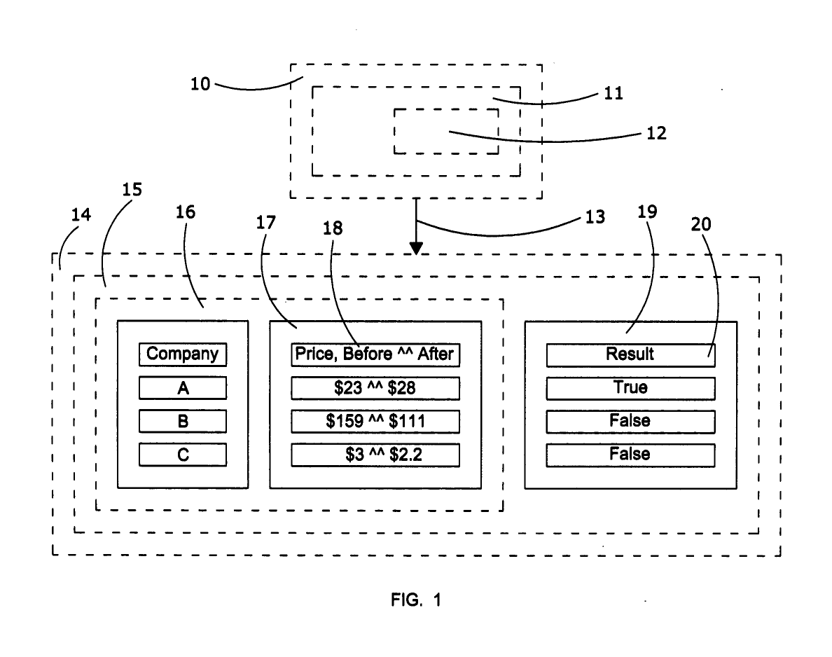

FIG. 1 is a block diagram showing an application software 10 and a spreadsheet 14. Application software 10 has a data 11. Data 11 have a plurality of values 12. Data 11 are selected and then copied. A change of application software 13 is performed from application software 10 to spreadsheet 14. Data 11 are pasted in worksheet 15 for obtaining a cells of data 16. Cells 16 have a column 17. Column 17 includes a plurality of cells 18. Cells 18 contain the values 12. Values 12 are formed by a first numerical value and a second numerical value which are separated by a common character. Worksheet 15 has a column 19. Column 19 includes a plurality of cells with formula 20. Cells 20 are referred directly to cells 18. Column 19 is referred directly to column 17. Cells 20 include worksheet functions which are executed in relation to cells 18 for obtaining a result between the first numerical value and the second numerical value which are separated by the common character.

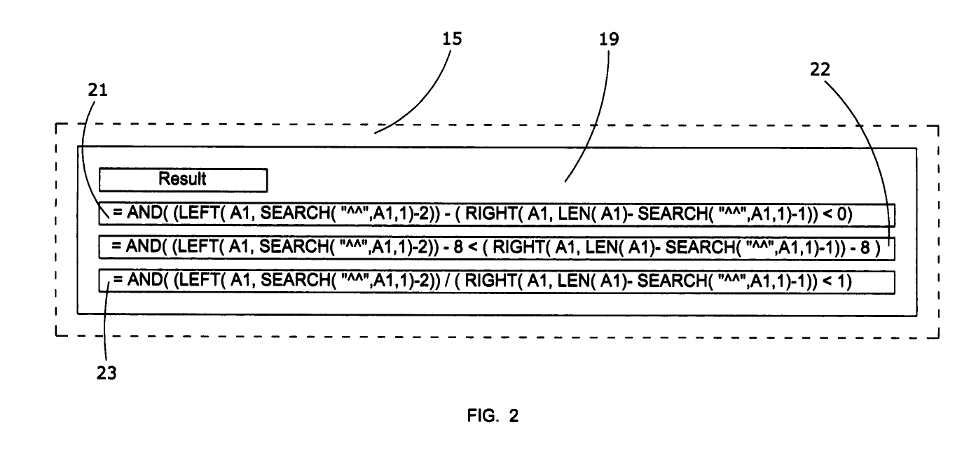

FIG. 2 is a block diagram showing formulas in column 19 for obtaining the result referred to column 17 in worksheet 15. Column 19 has a worksheet function 21, including an inequality which is referred to a zero value. Column 19 has a worksheet function 22, including an inequality for adding a same value with a same mathematical operation; and a worksheet function 23, including an inequality which is referred to a one value. Functions 21, 22 and 23 show several nested functions and arguments which are referred directly to cells 18 for obtaining the result between the first numerical value and the second numerical value which are separated by the common character in the worksheet 15. Functions 21, 22 and 23 are formulated for using the same column 19.

### Advantages

From the description above, a number of advantages of my process for obtaining the result between the first numerical value and the second numerical value which are separated by the common character in the plurality of cells with formula in the spreadsheet become evident:

(a) The result is obtained in the plurality of cells with formula in a single column without the need for inserting or using additional columns.

(b) With the use of the plurality of cells with formula having a plurality of built-in worksheet functions in the form of nested functions with the appropriate arguments, a different conditions respect the content of the plurality of values in the data can be treated, such as a change in the number of the numerical values, or a change in the common character, or a variation in the content for a specific value.

(c) The use of the process can replace a worksheet program for converting text to columns in the spreadsheet.

(d) The use of the process is particularly suitable when the data have multiple changes in time and there is a need of several operations for selecting, copying and pasting the data from application software to spreadsheet.

### Conclusion, Ramifications, and Scope

Accordingly, the reader will see that the process for obtaining the result between the first numerical value and the second numerical value which are separated by the common character of this invention can be used with several types of data such as, for example, a changes of stock prices, products or services values, financial data and economic values, and the like; and these data are in an application software and they are analyzed in the spreadsheet.

Moreover, the process of this invention can be completely incorporated in a worksheet program in the spreadsheet easily its application by a user, replacing the use of another worksheet program for converting text to columns in the spreadsheet.

The above description provides an illustrative version of the present invention. It should be clear that many modifications to the invention may be made without departing from its scope. For instance, it would be possible to include only some of the elements of the present invention without exceeding the essence of the present invention. Therefore, the scope of the present invention is to be limited only by the following claims.

What is claimed is:

1. A process for obtaining a result between a first numerical value and a second numerical value which are separated by a common character in a plurality of cells with formula in a spreadsheet, said process comprising:
a) using an application software in a computer and having a data in said application software,
b) having a plurality of values in said data,
c) having said plurality of values said first numerical value and said second numerical value which are separated by said common character,
d) selecting said data in said application software,
e) copying said data in said application software,
f) using said spreadsheet and selecting a cells of data in a worksheet,
g) pasting said data in said cells of data,
h) identifying a column having a plurality of cells with said plurality of values in said cells of data,
i) providing a column having said plurality of cells with formula referred directly to said column having said plurality of cells with said plurality of values,
j) providing a worksheet function in said plurality of cells with formula for finding said common character in said plurality of cells with said plurality of values,
k) providing a worksheet function in said plurality of cells with formula for finding said first numerical value in said plurality of cells with said plurality of values using said function for finding said common character in said plurality of cells with said plurality of values,
l) providing a worksheet function in said plurality of cells with formula for finding said second numerical value in said plurality of cells with said plurality of values using said function for finding said common character in said plurality of cells with said plurality of values; and,
m) providing a worksheet function in said plurality of cells with formula for obtaining said result between said first numerical value with said second numerical value using an inequality.

2. The process of claim 1 wherein said inequality is referred to a zero value.

3. The process of claim 1 wherein said inequality adds a same value with a same mathematical operation.

4. The process of claim 1 wherein said inequality is referred to a one value.
